(19) United States
(12) Patent Application Publication
(10) Pub. No.: US 2004/0019471 A1
(43) Pub. Date: Jan. 29, 2004

(54) Loading method and program

(76) Inventors: Kevin Joe Bush, Newport, WA (US); Christopher Robin Martin, Newport, WA (US)

Correspondence Address: John B. Hardaway, III, Nexsen Pruet Jacobs & Pollard, LLC, 201 West McBee Avenue, Suite 400, Post Office Drawer 10648, Greenville, SC, 29603, US

(21) Appl. No.: 10/206,616

(22) Filed: Jul. 26, 2002

(51) Int. Cl. G06G 7/48

(52) U.S. Cl. 703/6

(57) ABSTRACT

A computer-assisted method of graphically displaying one or more trailer load patterns for rolls of paper such that the load upon each axle of the trailer and corresponding tractor is maximized within physical and legal limits.

### FIELD OF THE INVENTION

The present invention generally relates to the loading of haulage vehicles, and particularly to the computer-assisted creation, selection and utilization of specific loading patterns so as to maximize the load on each axle of a tractor-trailer.

### BACKGROUND OF THE INVENTION

The process of loading products into a tractor-trailer for transport is not unlike putting together a jigsaw puzzle. There are a certain number of pieces and a limited amount of space in which to put them. Simply dumping all the products into the empty trailer will produce a result similar to tossing a set of jigsaw pieces into an empty puzzle board: almost certainly, the pieces will not fit and the result will be unsuccessful and time-consuming.

The primary goal of loading a tractor-trailer is to put as much product into the trailer for transport as is physically, legally and safely possible. Care must be taken to eliminate damage to the product from repeated loading and unloading, along with possible shifting or other damage occurring during transport. Failing to load the product properly on the first attempt results in loss of man-hours when the product must be reloaded, perhaps multiple times.

There are laws in the individual states which regulate the maximum loads and trailer characteristics which are allowable on their roads, and these must be taken into account when preparing a load for shipment. If the tractor-trailer is underutilized, then more trips are required to transport the product, each additional trip increasing wear and tear on the vehicle, taking up additional man-hours, and carrying with it the potential of accident and damage. Ultimately, both overloading and underloading increase the cost of shipping.

One approach to monitoring the weight of a haulage vehicle is to mount sensors at strategic locations on the vehicle frame, suspension, hinge assemblies and/or hydraulic cylinders. A computer may be used to monitor the vehicle weight and extrapolate anomalies related to load density or load shifting, thereby allowing the vehicle to be loaded up to its haulage limits in a stable fashion.

While this may be effective for monitoring axle load, it does not address the problem of determining trailer load patterns so as to achieve the most efficient and economical use of space within a trailer. Neither does it address the problem of there being many different combinations of tractors and trailers, all with different dimensions and load capacities. Neither does it take into account the differing laws of each destination jurisdiction.

The problems addressed above are even more prevalent in the transport of rolls of paper. There are examples of prior art which use a computer system to assist in trailer loading; however, they do not address the loading of rolls or cylinders, only square products. Rolls and cylinders present greater difficulty due to the space existing between the rolls and cylinders after being loaded, and the inherent tendency of cylindrical objects to slide and roll. The prior art also does not address the issue of generating interlocking load patterns, and utilizes a database format, resulting in extensive data entry when load details, carriers, trailers, tractors and laws change.

Inefficiencies in the transport of goods result in a higher cost of those goods, a premium which is ultimately paid by the consumer. The human cost of wasted man-hours and increased potential for product damage are substantial. Even small improvements in the efficiency of loading trailers can result in significant cost savings, as well as reduce the possibility of damage to the goods during transport.

While the above-stated devices are a fair representation of the current prior art, there remains room for improvement as defined by the currently-claimed invention.

### BRIEF SUMMARY OF THE INVENTION

An object of the present invention is to provide a computer-assisted method of predetermining trailer load patterns for rolls of paper such that the load upon each axle of the trailer and corresponding tractor is maximized within physical and legal limits.

It is an important object of the invention to provide a graphical display of trailer load patterns which will facilitate faster and more efficient loading of trailers with rolls of paper.

It is another object of the invention to eliminate the inefficient loading and transporting resulting from a non-computer aided creation of loading patterns.

It is a further object of the invention to provide interactive loading assistance by alerting the user when another roll may be loaded onto the selected trailer without exceeding the predetermined limits or when the load maximums have been exceeded and a roll must be removed.

Other objects and advantages of the invention will be apparent from the following detailed description and the accompanying drawings.

Briefly, in accordance with the invention, a computer-aided method is utilized to determine at least one load pattern for rolls of paper one a selected tractor and trailer. A list of tractors and trailers and their properties, such as weight, dimensions and load limits, is provided for the user. Once information related to the paper to be loaded and the destination is obtained and input into the system, the system compares the input to stored formulas and parameters to calculate at least one load pattern. This load pattern is output to a display or printer and used as a blueprint for the user in loading the trailer.

### BRIEF DESCRIPTION OF THE DRAWINGS

FIG. 1A illustrates a side view of a tractor-trailer loaded with rolls of paper which are stacked “on end.”

FIG. 1B illustrates a side view of a tractor-trailer loaded with rolls of paper which are “bilge” loaded.

FIG. 2 is a screen shot of one of the embodiments of the invention.

FIG. 3 is a screen shot of one of the embodiments of the invention.

FIG. 4 is a screen shot of one of the embodiments of the invention.

FIG. 5 is a flow chart illustrating generating a load pattern for “on-end” loads.

FIG. 6 is a flow chart illustrating manually generating a load pattern for “on-end” loads.

FIG. 7 is a flow chart illustrating manually generating a load pattern for “bilge” loads.

### DETAILED DESCRIPTION OF THE INVENTION

The present invention consists of a computer-aided method for generating one or more trailer load patterns for rolls of paper. It is an object of the present invention to generate a load pattern which allows for the most rolls of paper to be loaded onto a trailer for transport. By maximizing the load on each axle of the transport vehicle, the invention results in cost and efficiency savings.

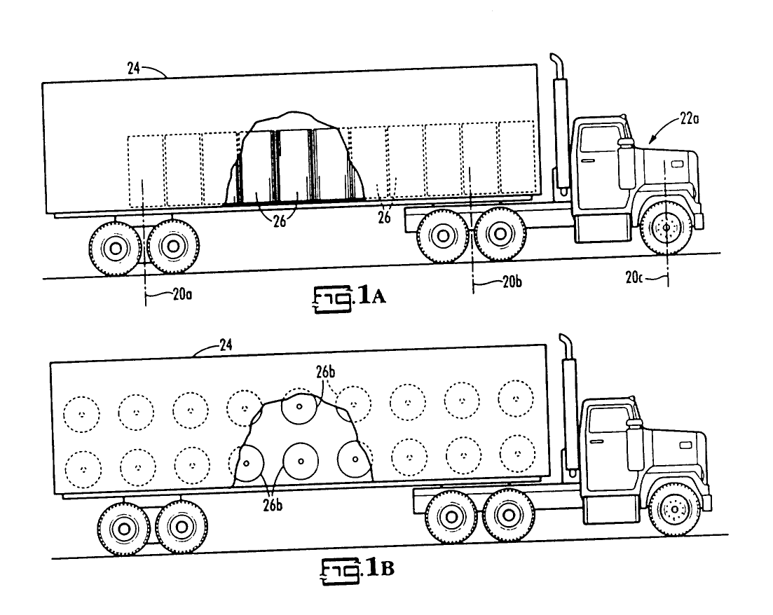

FIG 1A illustrates a trailer 24 loaded with rolls of paper 26A in accordance with the invention. A trailer 24 loaded with rolls of paper 26A is attached to a tractor 22. The rolls of paper 26A in FIG. 1 are loaded “on end,” that is, resting on one of its two opposing ends. Rolls loaded in this fashion may be stacked on top of each other in a stable fashion. One advantage of the invention is the ability to calculate loading patterns for round objects rather than square. The space inherently existing between round objects and a square enclosing space poses a more challenging problem than loading square objects into a square enclosure. The present invention further enables users to maximize the load on each axle 20A-20C of the transport vehicle. While there are three axles in the example of FIG. 1, other configurations are envisioned.

FIG 1B illustrates a trailer 24 loaded with rolls of paper 26B which are “bilge” loaded. “Bilge” loading encompasses loading the rolls on their circumferential surface. The rolls are secured and may be stacked on top of each other in a fashion known in the art.

In the preferred embodiment of the invention, a computer system is used. The system may, for example, be of the personal computer type, with a processor, memory storage means, persistent storage means, display means such as a monitor and input means such as a keyboard and mouse. The system may run a commercially available operating system, such as one of the Windows-based operating systems or Unix. In the preferred embodiment, Microsoft Windows is used, and a spreadsheet program is executed to facilitate and automate the calculations and data entry necessary to implement the invention. In the preferred embodiment, Microsoft Excel is the spreadsheet of choice. The spreadsheet file may be customized with macros, which are small programs, often user-created, and embedded within other programs.

The preferred embodiment consists of a Microsoft Excel document which contains macros to facilitate certain tasks. The spreadsheet may consist of one or more worksheets, which are differing embodiments of a spreadsheet file contained within one document. The preferred embodiment contains three worksheets.

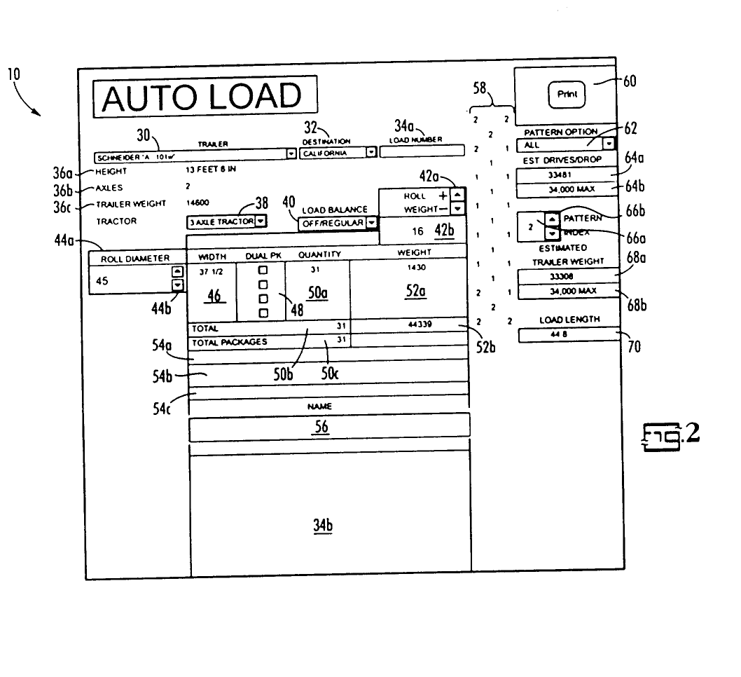

FIG. 2 is an illustration of one of the worksheets which is designed to generate load patterns for loads which are to be loaded on end. A user selects the trailer which is to be loaded using a drop-down menu 30. The list comprises numerous trailers which may be used, and the properties of each, comprising length, width, number of axles, interior and exterior height, weight, front portion weight, maximum capacity and center point. The values are used as variables in the equations which are used to generate load patterns. The trailer properties data is maintained on a separate, password-protected worksheet within the spreadsheet which is the preferred embodiment of the invention. Once a trailer selection is made, properties comprising the trailer height 36A, number of axles 36B, and total weight 36C may be displayed.

A user then selects the load destination state from a drop-down menu 32. Each state has differing laws regarding things such as trailer weight and load distribution. The selection of a destination affects the composition of the formulas used to generate load patterns; by doing so, the invention assures that any load pattern generated for a particular destination accounts for the laws of the destination state. A load number or other identifying load information may be entered 34A, and the information is subsequently displayed 34B in larger type for use when the load information may be printed.

A user then, via a drop-down menu 38, selects the type of tractor which may be used to haul the selected trailer. The selected trailer 30 and tractor 38 are compared to see if they are compatible. If not, an alert is displayed to a user in one of several message boxes 54A-54C, and the user may then take action to reserve a compatible trailer or tractor for the load.

The process of selecting the rolls to be loaded on the selected trailer may then begin. A user should first determine if there are rolls of varying widths being transported in the same load. If so, then the rolls should be entered in the order they are to be loaded into the trailer. The diameter of the rolls to be loaded is chosen in the Roll Diameter cell 44A by entering the diameter directly or adjusting a value with the arrows 44B. While this embodiment of the invention generates load patterns for rolls which are all of the same diameter, variations which handle rolls of more than one diameter are envisioned. The width of the rolls to be loaded first is entered in the width cell column 46. If there are rolls of differing widths to be loaded, they should be entered in the width column 46 in the order they are to be loaded. Rolls which are dual packed may be indicated such by checking the dual pack box 48 for each width roll. The quantity of each roll may be entered in the quantity cell column 50A. A running total of the amount of rolls to be loaded is calculated in the total cell 50B, and the total packages cell 50C adjusts the total by taking dual packed rolls into consideration.

In each row of rolls, the weight of each roll is calculated and displayed in the weight cell column 52A. This amount is calculated by an embedded formula which takes roll diameter and width into consideration. If the individual roll weight calculation is incorrect, it may be adjusted via the roll weight cell 42B. A value may be adjusted using the arrows 42A. The roll weight value should be adjusted until the amount in the weight cell column 52A matches the actual weight of the corresponding paper rolls. The total weight of all rolls is displayed in the total weight cell 52B. The total load weight, if known, may be matched exactly by using the roll weight adjuster 42B.

The message cells 54A-54C display alerts to a user upon the occurrence of events such as data entry errors, mismatched tractors and trailers, or weight alarms. The name of the user may be input into the name cell 56.

Once all the rolls in a load are input, a load pattern for the rolls may be selected by using the pattern option drop-down menu 62. A pattern for the rolls is then generated and displayed in the load pattern area 58. The pattern area represents an overhead view of a trailer whereby rolls are represented by circles with a numeral inside. The numeral corresponds to the number of rolls which are to be stacked in the corresponding position in the trailer. This pattern is filled in automatically and uses all the rolls entered and indicated in the total cell 50B. If a user desires a different pattern, a different load pattern option is chosen from the drop-down list 62 and a new pattern corresponding to the choice is generated and displayed. Several different variations on each pattern may be generated and displayed by using the pattern index selector 66A. The index may be adjusted via the arrow controls 66B. The process of selecting a pattern and a variation on that pattern maybe repeated until the user is satisfied. In each case, the pattern generated is one for which the weight on each axle of the selected tractor-trailer combination is maximized within the limits of the values of the tractor-trailer combination and the destination location. Based upon the order in which the rolls were entered and the corresponding quantity, the present invention calculates how the packages should be loaded to maximize each axle's capacity, and the most efficient loading pattern which meets all the weight distribution requirements is selected and displayed for use in loading the trailer.

The trailer weight is then calculated and displayed in the trailer weight cell 68A, while the maximum weight for the selected trailer is also displayed 68B. The load length, based upon the load pattern generated, is displayed in the load length cell 70. When a loaded trailer is put on the scales a portion of the trailer weight will be on the axles of the tractor. This is the Estimated Drives Drop weight for a specific tractor/trailer combination and is displayed in the “Est. Drives/Drop” cell 64A, while the maximum Estimated Drives Drop Weight for the selected tractor/trailer combination is also displayed 64B.

Finally, the entire worksheet, including the load pattern, may be printed by clicking the print button 60 so that the shippers may carry the printout with them as they load.

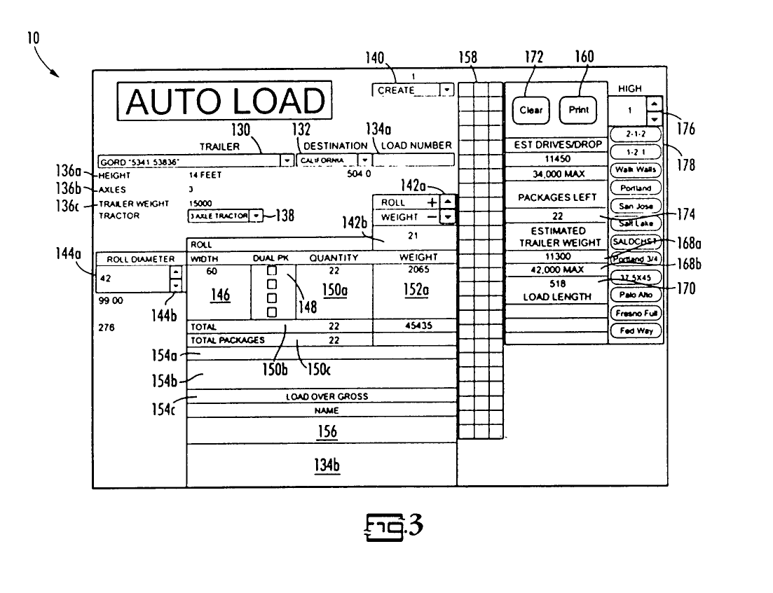

FIG. 3 illustrates an alternate worksheet available in the invention, the primary difference being that by using this worksheet, a user may create a load pattern manually and with computer guidance in addition to having a pattern automatically generated.

A trailer is chosen from the trailer drop-down list 130 as well as a destination from the destination drop-down list 132. As before, a load number may be entered 134A and displayed in large type for printing 134B. Once a trailer selection is made, properties comprising the trailer height 136A, number of axles 136B, and total weight 136C are displayed.

A user then, via a drop-down menu 138, selects the type of tractor which may be used to haul the selected trailer. The selected trailer 130 and tractor 138 are compared to see if they are compatible. If not, an alert is displayed to a user in one of several message boxes 154A-154C, and the user may then take action to reserve a compatible trailer or tractor for the load.

If there are rolls of varying widths being transported in the same load, then the rolls should be entered in the order they are to be loaded into the trailer. The diameter of the rolls to be loaded is chosen in the Roll Diameter cell 144A by entering the diameter directly or adjusting a value with the arrows 144B. While this embodiment of the invention generates load patterns for rolls which are all of the same diameter, variations which handle rolls of more than one diameter are envisioned. The width of the rolls to be loaded first is entered in the width cell column 146. If there are rolls of differing widths to be loaded, they should be entered in the width column 146 in the order they are to be loaded. Rolls which are dual packed may be indicated such by checking the dual pack box 148 for each width roll. The quantity of each roll may be entered in the quantity cell column 150A. A running total of the amount of rolls to be loaded is calculated in the total cell 150B, and the total packages cell 150C adjusts the total by taking dual packed rolls into consideration.

In each row of rolls, the weight of each roll is calculated and displayed in the weight cell column 152A. This amount is calculated by an embedded formula which takes roll diameter and width into consideration. If the individual roll weight calculation is incorrect, it may be adjusted via the roll weight cell 142B. A value may be entered directly or adjusted using the arrows 142A. The roll weight value should be adjusted until the amount in the weight cell column 152A matches the actual weight of the corresponding paper rolls. The total weight of all rolls is displayed in the total weight cell 152B. The total load weight, if known, may be matched exactly by using the roll weight adjuster 142B.

The message cells 154A-154C display alerts to a user upon the occurrence of events such as data entry errors, mismatched tractors and trailers, or weight alarms. The name of the user may be input into the name cell 156.

Once all the rolls which are to be loaded have been input, a user may select a predetermined load pattern button 178 and a pattern for the rolls is then generated and displayed in the load pattern area 158. The pattern area represents an overhead view of a trailer and is subdivided into boxes, each box representing an area of the trailer in which a roll of paper may be loaded on end. A numeral inside each box indicates how many rolls are stacked in the specific area. A user may adjust the number of rolls to be stacked in each area for the complete load by using the load height adjustment cell 176. If a user wants to select another predetermined load pattern, the clear button 172 will activate a macro which clears the load pattern area 158.

The pattern generated is one for which the weight on each axle of the selected tractor-trailer combination is maximized within the limits of the values of the tractor-trailer combination and the destination location. Based upon the order in which the rolls were entered and the corresponding quantity, the present invention calculates how the packages should be loaded to maximize each axle's capacity, and the most efficient loading pattern which meets all the weight distribution requirements is selected and displayed for use in loading the trailer.

If desired, a user may manually enter into the load pattern area 158 the number of rolls and the exact position within the trailer they are to be loaded. The number of rolls left to be loaded is displayed in the packages left cell 174 so the user knows how many rolls are remaining to load. After each entry, the present invention compares the manually-entered pattern to the weight distribution requirements and alerts the user of unallowable conditions via the message boxes 154A-154C.

The trailer weight is then calculated and displayed in the trailer weight cell 168A, while the maximum weight for the selected trailer is also displayed 168B. The load length, based upon the load pattern generated, is displayed in the load length cell 170. When a loaded trailer is put on the scales a portion of the trailer weight will be on the axles of the tractor. This is the Estimated Drives Drop weight for a specific tractor/trailer combination and is displayed in the “Est. Drives/Drop” cell 164A, while the maximum Estimated Drives Drop Weight for the selected tractor/trailer combination is also displayed 164B.

Finally, the entire worksheet, including the load pattern, may be printed by clicking the print button 160 so that the shippers may carry the printout with them as they load.

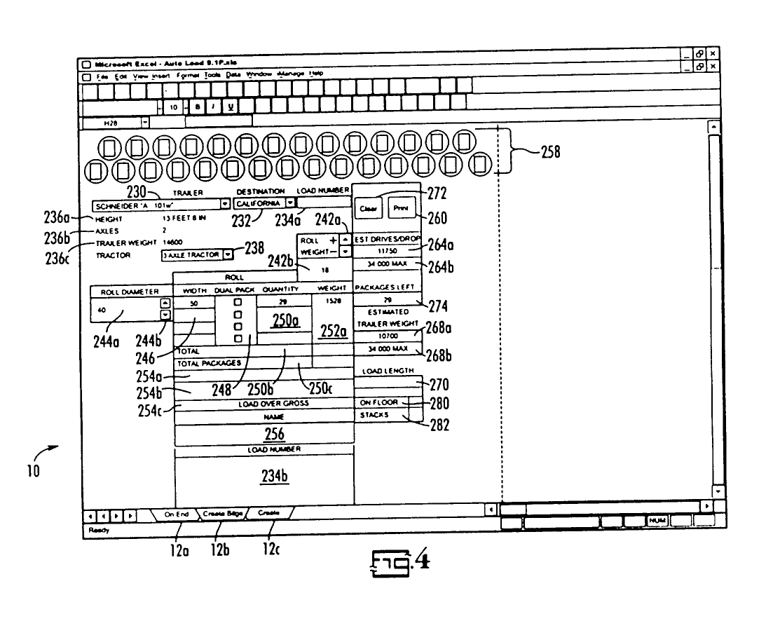

FIG. 4 is an illustration of an alternate worksheet available in the invention which is designed to enable a user manually to create a load pattern to be bilge loaded. An automatic generation of a bilge-loaded load pattern is a potential embodiment of the invention.

A user selects a trailer which is to be loaded using a drop-down menu 230. The list comprises numerous trailers which may be used. The properties of each, comprising length, width, number of axles, interior and exterior height, weight, front portion weight, maximum capacity and center point, are maintained on a separate, password-protected worksheet within the spreadsheet which is the preferred embodiment of the invention. The properties are used as variables in the equations which are used to generate load patterns. Once a trailer selection is made, properties comprising the trailer height 236A, number of axles 236B, and total weight 236C are displayed.

A user may then select the state to which the load is being shipped from a drop-down menu 232. The selection of a destination affects the composition of the formulas used to generate load patterns due to each state having potentially different laws regarding shipping. This individual state data is maintained on a separate worksheet within the present invention. The invention assures that any load pattern generated for a particular destination accounts for the laws of the destination state. A load number or other identifying load information may be entered 234A, and the information is subsequently displayed 234B in larger type for use when the load information may be printed.

A user then, via a drop-down menu 238, selects the type of tractor which may be used to haul the selected trailer. The selected trailer 230 and tractor 238 are compared to see if they are compatible. If not, an alert is displayed to a user in one of several message boxes 254A-254C, and the user may then take action to reserve a compatible trailer or tractor for the load.

The process of selecting the rolls to be loaded involves determining if there are rolls of varying widths being transported in the same load. If so, then the rolls should be entered in the order they are to be loaded into the trailer. The diameter of the rolls to be loaded is chosen in the Roll Diameter cell 244A by entering the diameter directly or adjusting a value with the arrows 244B. While this embodiment of the invention generates load patterns for rolls which are all of the same diameter, variations which handle rolls of more than one diameter are envisioned. The width of the rolls to be loaded first is entered in the width cell column 246. Rolls of differing widths are entered in the width column 246 in the order they are to be loaded. Dual-packaged rolls are indicated as such by checking the dual pack box 248 for each width roll. The quantity of each roll is entered in the quantity cell column 250A. A running total of the amount of rolls to be loaded is calculated in the total cell 250B, and the total packages cell 250C adjusts the total by taking dual packed rolls into consideration.

In each row of rolls, the weight of each roll is calculated and displayed in the weight cell column 252A. This amount is calculated by an embedded formula which takes roll diameter and width into consideration. If the individual roll weight calculation is incorrect, it maybe adjusted via the roll weight cell 242B. A value may be adjusted using the arrows 242A. The roll weight value should be adjusted until the amount in the weight cell column 252A matches the actual weight of the corresponding paper rolls. The total weight of all rolls is displayed in the total weight cell 252B. The total load weight, if known, may be matched exactly by using the roll weight adjuster 242B.

The message cells 254A-254C display alerts to a user upon the occurrence of events such as data entry errors, mismatched tractors and trailers, or weight alarms. The name of the user may be input into the name cell 256.

The bilge load pattern area 258 represents a side view of a trailer. Each potential area in the trailer which may be loaded with a roll of paper is represented by a circle with a numeral inside. The numeral represents how many rolls are to be loaded in the corresponding horizontal area. If, based upon the width of the rolls and the width of the trailer, too many rolls are attempted to be loaded into a particular area, a message will appear in the message area 254A-254C.

The number of rolls left to be loaded is displayed in the packages left cell 274 so the user knows how many rolls are remaining to load. After each entry, the present invention compares the manually-entered pattern to the weight distribution requirements and alerts the user of unallowable conditions via the message boxes 254A-254C.

The trailer weight is then calculated and displayed in the trailer weight cell 268A, while the maximum weight for the selected trailer is also displayed 268B. The load length, based upon the load pattern generated, is displayed in the load length cell 270. When a loaded trailer is put on the scales a portion of the trailer weight will be on the axles of the tractor. This is the Estimated Drives Drop weight for a specific tractor/trailer combination and is displayed in the “Est. Drives/Drop” cell 264A, while the maximum Estimated Drives Drop Weight for the selected tractor/trailer combination is also displayed 264B.

Finally, the entire worksheet, including the load pattern, may be printed by clicking the print button 260 so that the shippers may carry the printout with them as they load.

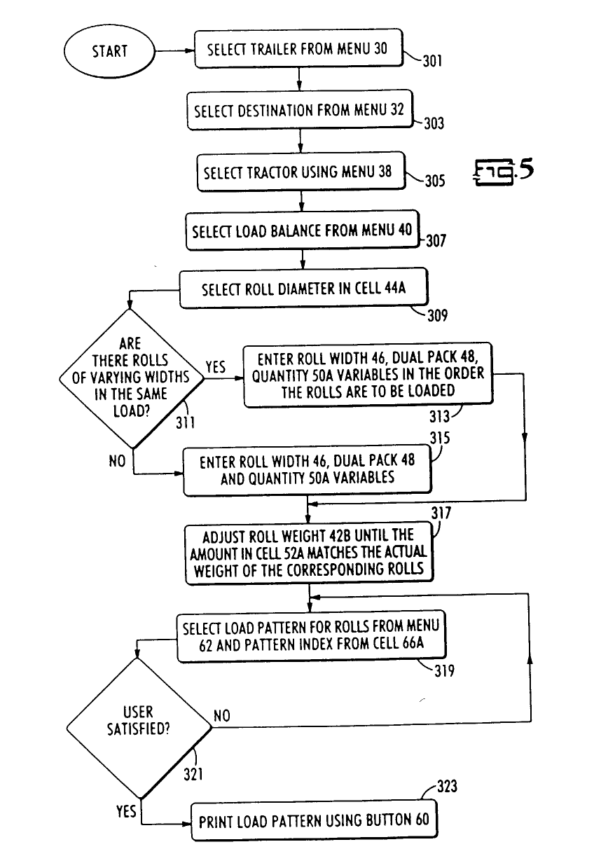

FIG. 5 illustrates the necessary steps to generate a load pattern for loads which are to be loaded on end. First 301 the user selects a trailer to be loaded using a drop-down menu 30. Next 303 the user selects the load destination from a drop-down menu 32. Then 305 the type of tractor used to haul the selected trailer is chosen via drop-down menu 38. If necessary, the user then 307 selects the appropriate load balance via drop-down menu 40. Then 309 the diameter of the rolls is chosen in the Roll Diameter cell 44A. If there are rolls of varying widths in the same load 311, then the user enters 313 the roll width 46, dual pack 48, and quantity 50A variables in the order that the rolls are to be loaded. If all the rolls are of the same width, then 315 the user enters the roll width 46, dual pack 48, and quantity 50A variables for each differing roll width. Next 315 the user adjusts the roll weight 42B until the amount in cell 52A matches the actual weight of the corresponding rolls. The user then 319 selects a load pattern for the rolls from a drop-down menu 62 along with a pattern index from cell 66A. If the user is satisfied 321 with the resultant pattern, the pattern maybe printed 323 using the print button 60. Otherwise, the user may select a different load pattern 62 and pattern index 66A.

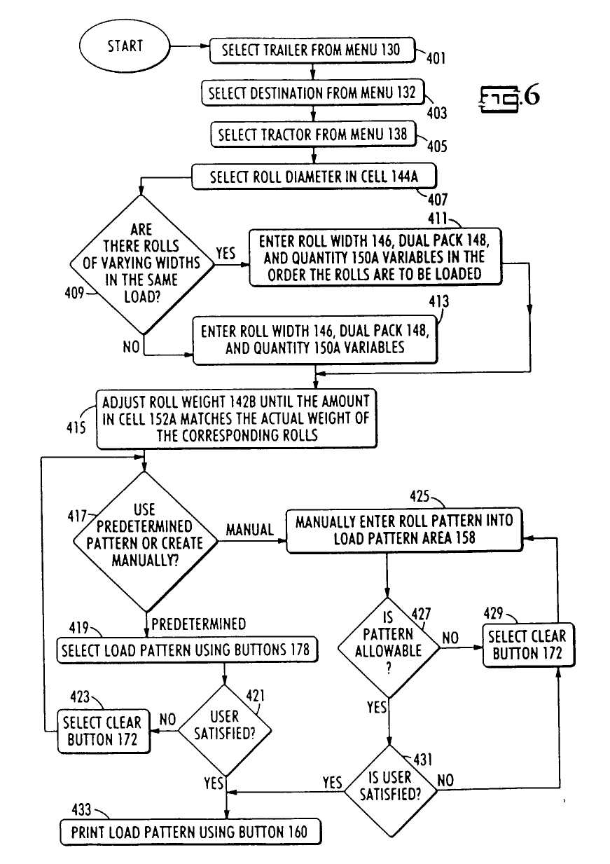

FIG. 6 illustrates the necessary steps to generate manually a load pattern for loads which are loaded on end. First 401 the user selects a trailer to be loaded using a drop-down menu 130. Next 403 the user selects the load destination from a drop-down menu 132. Then 405 the type of tractor used to haul the selected trailer is chosen via drop-down menu 138. Then 407 the diameter of the rolls is chosen in the Roll Diameter cell 144A. If there are rolls of varying widths in the same load 409, then the user enters 411 the roll width 146, dual pack 148, and quantity 150A variables in the order that the rolls are to be loaded. If all the rolls are of the same width, then 413 the user enters the roll width 146, dual pack 148, and quantity 150A variables for each differing roll width. Next 413 the user adjusts the roll weight 142B until the amount in cell 152A matches the actual weight of the corresponding rolls. Next 417 the user decides whether to use a predetermined load pattern or create one manually. If the user decides to use a predetermined load pattern, a load pattern is selected 419 using the buttons in cell 178. If the user is satisfied 421, then the load pattern may be printed 433 using the print button 160. If the user is not satisfied, the user presses 423 the clear button 172 and begins anew with step 417. In order to create a load pattern manually, the user enters 425 a roll pattern into the load pattern area 158. If the pattern is allowable 427, taking weight and room into account, and the user is satisfied 431, then the load pattern may be printed 433 using the print button 160. If the pattern is unallowable 427 or the user is dissatisfied 431, then 429 the user presses the clear button 172 and begins anew with step 417.

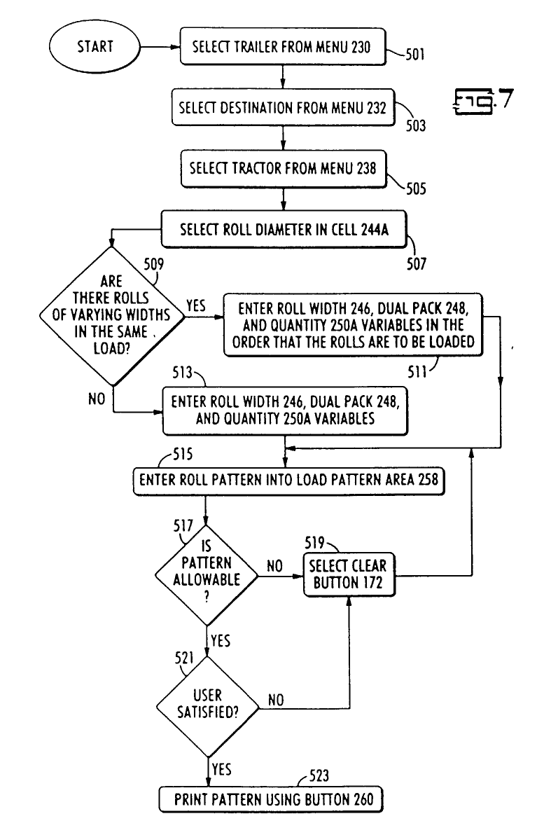

FIG. 7 illustrates the necessary steps to generate manually a load pattern for loads that are to be bilge loaded. First 501 the user selects a trailer to be loaded using a drop-down menu 230. Next 503 the user selects the load destination from a drop-down menu 232. Then 505 the type of tractor used to haul the selected trailer is chosen via drop-down menu 238. Then 507 the diameter of the rolls is chosen in the Roll Diameter cell 244A. If there are rolls of varying widths in the same load 509, then the user enters 511 the roll width 246, dual pack 248, and quantity 250A variables in the order that the rolls are to be loaded. If all the rolls are of the same width, then 513 the user enters the roll width 246, dual pack 248, and quantity 250A variables for each differing roll width. Next, the user enters 515 a roll pattern into the load pattern area 258. If the pattern is allowable 517, taking weight and room into account, and the user is satisfied 521, then the load pattern may be printed 523 using the print button 260. If the pattern is unallowable 517 or the user is dissatisfied 521, then 519 the user presses the clear button 272 and begins anew with step 515 Although the present invention has been described in detail, it should be understood that the method described herein and illustrated in the drawings is subject to other advantages and modifications that may be apparent to those of ordinary skill in the art without departing from the spirit and scope of the appended claims. Accordingly, the invention is to be limited only by the scope of the following claims and their equivalents.

What is claimed is:

1. A method for determining at least one load pattern for rolls of paper on at least one tractor and trailer combination, said method employing a computer system and comprising the steps of:
Collecting data comprising values related to said tractor and trailer to be loaded, a destination of a load of said rolls of paper, a diameter of said rolls of paper, a width of said rolls of paper, and a quantity of said rolls of paper;
Inputting said data into said computer system, said computer system comprising a data entry means, processing means, memory means, and output means;
Storing said data on said memory means;
Retrieving from said memory means predetermined stored formulas and parameters, said parameters comprising trailer dimensions, trailer load limits, number of said rolls of paper available for shipping and destination for said rolls of paper;
Processing with said processing means said data and parameters in said formulas to produce results, said results defining at least one load pattern for said trailer to be loaded with said rolls of paper for transport to one of said load destinations with said trailer within predetermined load limits;
Outputting with said output means said load pattern in a format usable for loading said rolls of paper onto said trailer.

2. The method of claim 1, wherein a software application is executed by said computer system.

3. The method of claim 2, wherein said software application is a spreadsheet software application.

4. The method of claim 3, further comprising adding code or capabilities to said spreadsheet software application.

5. The method of claim 4, wherein said step of adding code or capabilities to said spreadsheet software includes the use of one or a plurality of macros to graphically illustrate said load pattern.

6. The method of claim 1, further comprising a Graphical User Interface for inputting data into said computer system.

7. The method of claim 6, wherein said Graphical User Interface comprises menus, dialog boxes, computer-generated messages, restricted data entry, hidden formulas, hidden comments made visible on demand and an interactive help system.

8. The method of claim 1, wherein said results comprise a graphical representation of at least one trailer load pattern for rolls of paper.

9. The method of claim 1, further comprising customizing said load patterns by computer interaction comprising computer-generated messages and alerts.

10. The method of claim 9, wherein said computer interaction comprises messages displayed to a user, said messages assisting the user in loading said trailer without exceeding said trailer load limit.

11. The method of claim 1, wherein said output means is a printer.

12. The method of claim 1, wherein said load patterns include interlocking load patterns.

13. The method of claim 1, further comprising adjusting said predetermined parameters and formulas to factor in environmental accumulation on said tractor and trailer.

14. The method of claim 1, wherein said load pattern comprises at least one load pattern selected from a group consisting of a bilge load and an on end load.

15. A computer system for generating at least one load pattern for rolls of paper so that the load on each axle of a tractor and trailer used to transport said rolls is maximized within predetermined limits, said system comprising:
a computer having a processor and memory, the computer system executing an electronic spreadsheet software application that provides a loading pattern generation system;
parameters stored in said spreadsheet software application related to paper roll weight and quantity, weight distribution requirements and trailer dimensions and specifications;
formulas stored in said spreadsheet software application;
data entry means for said computer for entering data related to paper roll weights and quantity and trailer dimensions; and
a display for displaying product information derived from said parameters in a format readable for use in loading said rolls of paper onto said trailers.

16. The computer system according to claim 15, wherein said display means comprises monitors and printers.

17. The computer system according to claim 15, wherein said data entry means comprises keyboards and pointing devices.

18. The computer system according to claim 15, wherein said spreadsheet software application comprises means for computing said loading patterns based on said data entry and parameters.

19. The computer system according to claim 15, wherein said spreadsheet software application further comprises a plurality of worksheets.

20. The computer system according to claim 15, wherein said spreadsheet software application further comprises means for calculating and displaying interlocking load patterns.

21. The computer system according to claim 15, wherein said spreadsheet software application further comprises means for adjusting said load patterns to factor in environmental accumulation on said tractor and trailer.

22. The computer system according to claim 15, wherein said spreadsheet software application further comprises means for creating load patterns for rolls of paper to be loaded on end.

23. The computer system according to claim 15, wherein said spreadsheet software application further comprises means for creating load patterns for rolls of paper to be bilge loaded.

24. The computer system according to claim 15, wherein said spreadsheet software application further comprises messages displayed to the user in the event of data entry errors or entry of data outside of predetermined parameters.

25. The computer system according to claim 15, wherein said spreadsheet software application further comprises means for outputting said load patterns to external devices.

26. The computer system according to claim 15, wherein said spreadsheet software application further comprises messages displayed to the user, said messages displayed to a user, said messages assisting the user in loading said trailer without exceeding said trailer load limit.

27. A method for operating a computer to generate at least one trailer load pattern for rolls of paper, comprising the steps of operating a computer to:
Select, from a predetermined list, a combination comprising a tractor, trailer, and destination of said rolls of paper;
Calculate a maximum weight capacity and weight distribution requirement for said combination;
Input variables comprising roll diameter, roll width, and quantity of said rolls of paper;
Calculate a gross trailer weight from said combination and said variables;
Generate a trailer load pattern for said combination where said load pattern distributes said gross trailer weight among the axles of said trailer to a maximum extent without exceeding said weight distribution requirement or said maximum weight capacity; and
Display said trailer load pattern.

28. An electronic storage medium having code embodied therein that enables a processor to create at least one load pattern for rolls of paper on at least one trailer of a combination tractor and trailer, the electronic storage medium comprising:
code that enables a processor to process data related to said tractor and trailer combination, a destination of a load of said rolls of paper, a diameter of said rolls of paper, a width of said rolls of paper, and a quantity of said rolls of paper;
code that enables a processor to store said data;
code that enables a processor to retrieve predetermined stored formulas and parameters;
code that enables a processor to compare said data to said formulas and parameters;
code that enables a processor to generate at least one load pattern for loading a trailer with said rolls of paper for transportation to said destination and with said trailer loaded within predetermined limits;
code that enables a processor to output said load patterns.

29. The medium according to claim 28, wherein the code that enables a processor to process data further comprises code that enables a processor to utilize a Graphical User Interface.

30. The medium according to claim 28, wherein said load patterns are output on a printer.
